(19) United States
(12) Patent Application Publication
(10) Pub. No.: US 2010/0276907 A1
(43) Pub. Date: Nov. 4, 2010

(54) Trailer hitch security clamp

(76) Inventor: Ralph Scarola, Edison, NJ (US)

Correspondence Address: CLIFFORD G. FRAYNE, 136 DRUM POINT RD, SUITE 7A, BRICK, NJ, 08723, US

(21) Appl. No.: 12/589,091

(22) Filed: Oct. 19, 2009

Related U.S. Application Data
(60) Provisional application No. 61/215,049, filed on May 4, 2009.

(51) Int. Cl. B60D 1/02

(52) U.S. Cl. 280/507

(57) ABSTRACT

A two-piece security clamp for trailer hitches of the pintle and pintle ring type in order to prevent the unintended removal or theft of the trailer and its equipment, the security clamp having a first planar member dimensioned to cover the aperture of a pintle ring, the bottom surface of the first planar member having a perpendicular finger member extending perpendicular thereto, and depending through the aperture in the pintle ring, the planar member further having angularly extending wing members, which wing members extend a distance sufficient to cover or deny access to the bolts securing the pintle ring, there being a second clamp member having a surface area greater than the area of the aperture of the pintle ring, the second clamp member having a slot there through for the slidable receipt of the depending finger member, the lower surface of the second clamp member having a cylindrical cavity into which said depending finger member extends, the finger member having an aperture proximate its end for the accommodation of a padlock for securing the two clamp members together about the pintle ring, the cylindrical cavity denying access to the hasp of the padlock to prevent its being severed by bolt cutters.

### RELATED APPLICATIONS

Applicant claims the benefit of provisional application Ser. No. 61/215,049, filed May 4, 2009.

### BACKGROUND OF THE INVENTION

1. Field of the Invention

The present invention relates to a trailer hitch security clamp to prevent the theft or unintended removal of a trailer and its contents, and more particularly, to a security clamp for a pintle and pintle ring type trailer hitch.

2. Description of the Prior Art

Trailers are used in the industry for a wide variety of purposes. They are particularly useful with respect to the construction industry for transporting generators, lights, pumps, fluid or pneumatic equipment and for general hauling. The trailers to which this application applies can be closed or open and are normally attached to the rear of a heavy duty pick up truck or panel truck.

The manner in which the trailer is attached to the pulling vehicle varies. Applicant's invention relates to the trailer hitch commonly known as a pintle and pintle ring connection. This type of connection consists of a pintle member attached to the rear of a vehicle, the pintle being a hinged jaw-like member, the upper jaw-like member rotatable in relationship to the lower jaw-like member in a vertical plane. The pintle ring member is normally attached to the trailer and consists of a pintle ring shoulder and integral toroidal portion defining an aperture which is secured to the trailer by an attachment plate and plurality of bolts, the horizontal pintle ring is slidably secured within the lower jaw of the pintle member with the upper jaw being closed and secured by a locking pin.

Trailers of the type discussed are used on a daily basis in the construction industry and oftentimes are left on the construction site so the equipment contained thereon may be utilized until it is no longer required. While remaining on the construction site, the trailer is normally not attached to the vehicle so as to free the vehicle up for other purposes. The trailer is positioned with its equipment at a stationary location for use by the construction workers.

It is not unheard of to have an entire trailer with its equipment stolen from a construction site. The thief would merely have to have a vehicle with a pintle member secured thereto to back up to the solitary trailer and connect the pintle ring to the pintle member and haul the trailer away. One solution to this type of theft would be to remove the pintle ring from the trailer when it is in a stationary and unattended location. However, because of the wide spread use of the pintle and pintle ring trailer hitch, a thief having a vehicle with the pintle member attached thereto could simply attach a pintle ring to the trailer to accomplish the theft.

Additional attempts to thwart possible thievery include devices which lock onto the pintle ring member so as to cover up or partially block the aperture in the pintle ring thereby preventing the pintle ring from securely being engaged by the jaws of the pintle member. Thieves have thwarted this attempt by removing the bolts which secure the pintle ring to the trailer and substituting their own pintle ring in order to steal the trailer and its equipment.

Applicant's security clamp which is specifically directed to the pintle and pintle ring type trailer hitch, prevents the theft or unintended removal of the trailer and its equipment from a location by not only blocking the aperture of the pintle ring, but also blocking access to the bolts which secure the pintle ring thereby denying the potential thief the ability to use the trailer's pintle ring to connect to a pintle member and also denying the thief the ability to remove the trailer's pintle ring in order to substitute the thieves pintle ring.

### OBJECTS OF THE INVENTION

An object of the present invention is to provide a security clamp for a trailer hitch of the pintle and pintle ring type which denies access to the pintle ring and the securing bolts of the pintle ring in order to prevent theft.

Another object of the present invention is to provide for a novel security clamp for a trailer hitch of the pintle and pintle ring type in which the security clamp locks access to the aperture in the pintle ring and simultaneously denies access to the securing bolts which secure the pintle ring to the trailer.

### SUMMARY OF THE INVENTION

A two-piece security clamp for trailer hitches of the pintle and pintle ring type in order to prevent the unintended removal or theft of the trailer and its equipment, the security clamp having a first planar member dimensioned to cover the aperture of a pintle ring, the bottom surface of the first planar member having a perpendicular finger member extending perpendicular thereto, and depending through the aperture in the pintle ring, the planar member further having angularly extending wing members, which wing members extend a distance sufficient to cover or deny access to the bolts securing the pintle ring, there being a second clamp member having a surface area greater than the area of the aperture of the pintle ring, the second clamp member having a slot there through for the slidable receipt of the depending finger member, the lower surface of the second clamp member having a cylindrical cavity into which said depending finger member extends, the finger member having an aperture proximate its end for the accommodation of a padlock for securing the two clamp members together about the pintle ring, the cylindrical cavity denying access to the hasp of the padlock to prevent its being severed by bolt cutters.

### BRIEF DESCRIPTION OF THE DRAWINGS

These and other objects of the present invention will become apparent, particularly when taken in light of the following illustrations wherein:

FIG. 1 is a side view of a pintle and pintle ring assembly and pintle ring bracket;

FIG. 2 is a top view of a typical pintle, pintle ring, and pintle ring bracket;

FIG. 3 is an end view of a second embodiment of a pintle ring and pintle ring bracket;

FIG. 4 is a side view of a security clamp of the present invention being secured to a pintle ring of FIGS. 1 and 2;

FIG. 5 is a top view of a security clamp of FIG. 4;

FIG. 6 is a bottom view of the lower segment of the security clamp of FIG. 4; and

FIG. 7 is a side view of a security clamp of the present invention designed for the pintle ring of FIG. 3.

### DETAILED DESCRIPTION OF THE INVENTION

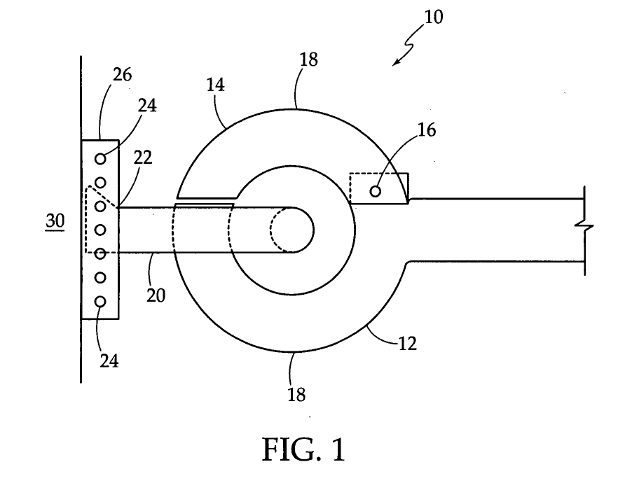

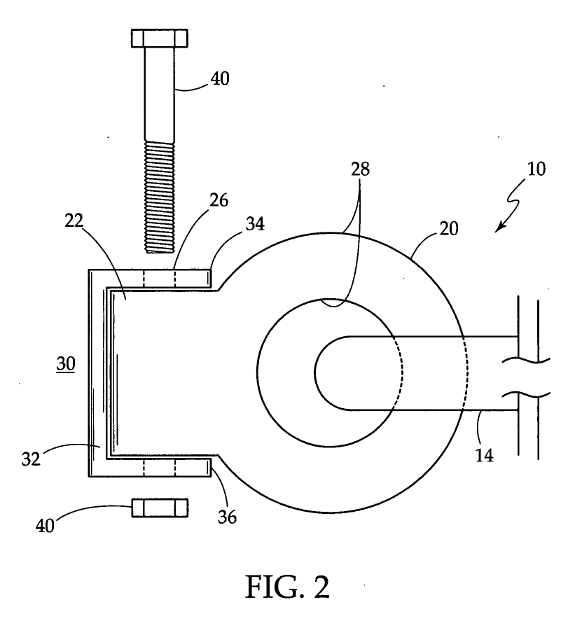

FIG. 1 is a side view of a pintle member, pintle ring, and pintle ring attachment plate or bracket. FIG. 2 is a top view of the aforesaid pintle, pintle ring, and pintle ring bracket. The pintle member 10 is of two-pieced hinged construction, there being a fixed lower jaw 12, and a rotatable upper jaw 14 rotatable around hinge or pivot point 16. When closed, the upper jaw and lower jaw of the pintle member form an aperture 18 in a vertical plane. The pintle ring 20 is of one piece construction and is unitarily formed with a shoulder member 22 which in one embodiment would have a plurality of apertures 24 there through for securing the pintle ring 20 to a trailer by means of attachment plate or bracket 26. The aperture 28 is defined by a toroidal portion of pintle ring 20 and is slightly greater than the circumference of the upper and lower jaws 12 and 14 of the pintle member 10. Similarly the aperture 18 defined by upper jaw 14 and lower jaw 12 of the pintle member 20 is slightly greater than the circumference of the aperture wall of pintle ring.

One manner of securing the pintle ring to a trailer is illustrated in FIGS. 1 and 2. In this configuration, a U-shaped attachment plate or bracket 26 is welded to the trailer or trailer tongue 30, this U-shaped bracket is of one piece construction having a backing member 32 and two leg members 34 and 36, the leg members having aligned apertures 24 there through. The shoulder 22 of the pintle ring 20 is slidably received between the two legs 34 and 36 of bracket 26 and the apertures or through bores, in the shoulder portion 22 of the pintle ring 20 are aligned with the apertures on the legs 34 and 36 of the bracket 26 and secured by the required number of bolt and nut members 40. Bracket 26 is normally fabricated with a plurality of alignable apertures to allow for the height adjustment of the shoulder 22 and pintle ring 20 in order to accommodate pintle members that may be at dissimilar heights on a vehicle.

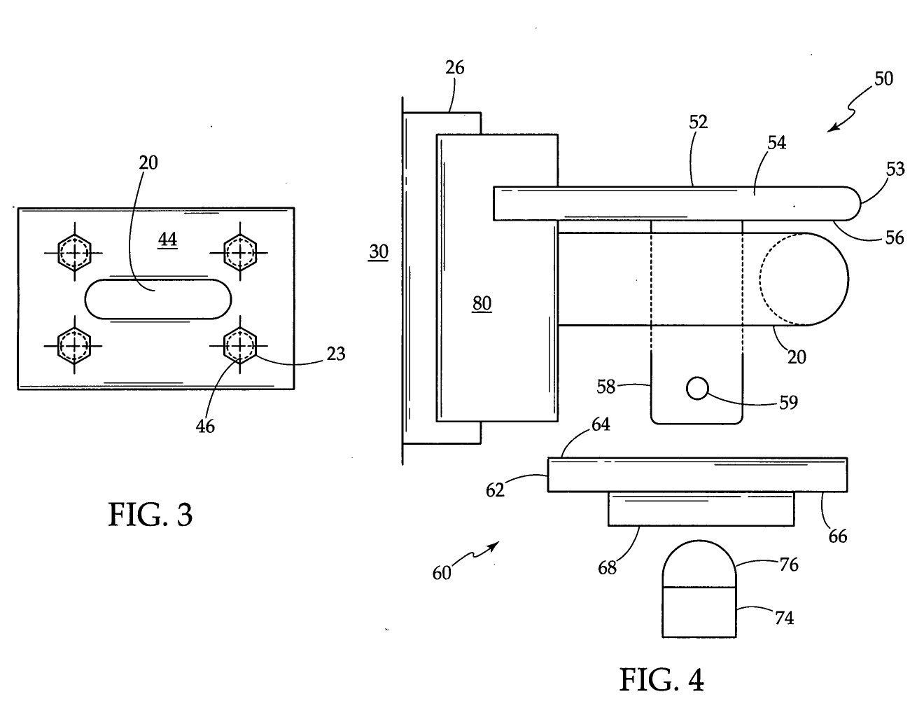

FIG. 3 is an end view of a second embodiment of a pintle ring 20 and method of mounting. The pintle ring 20 and shoulder portion 22 are identical to that as illustrated in FIGS. 1 and 2, however, the pintle ring shoulder 22 terminates in a plate member 44 having a plurality of apertures 46 which allow the pintle ring 20 and shoulder portion 22 to be bolted 23 directly to an upstanding member of the trailer. This particularly configuration provides for no adjustment of the height of the pintle ring 20 as does the bracket member 26 illustrated in FIGS. 1 and 2.

When the trailer and its equipment is disengaged from its vehicle, the trailer and the equipment may at times be left unattended. This could be because the trailer and its equipment is not in use and is in a stored location or the trailer and the equipment contained therein may be in use at a construction site or the like whereby the trailer and the equipment remain on site but unattended, such as overnight when no construction work is taking place. In these situations it is desirous to have some form of security to prevent a thief with a vehicle having a pintle attached thereto to approach the unattended trailer, hook the trailer to the thief's vehicle, and remove the trailer and its equipment.

Initial security attempts were directed to blocking the aperture into the pintle ring to deny the thief the ability to hook the pintle ring to the thief's pintle member. The thieves then thwarted this attempt by removing the bolts and nuts which secure the pintle ring to the bracket, the thieves then substituting their own pintle ring to the bracket and removing the trailer and its equipment. This type of theft was prevalent not only with respect to the pintle rings illustrated in FIGS. 1 and 2, but also the pintle ring illustrated in FIG. 3. There is therefore a need for a security means or security clamp which denied the thief access to the pintle ring aperture and also denied the thief access to the fastening means which secured the pintle ring to the bracket and the trailer.

FIG. 4 is a side view of the pintle ring 20 as illustrated in FIGS. 1 and 2. Pintle ring 20 is already secured to bracket 26 by means of securing means in the form of nuts and bolts 40. Security clamp 50 is of two-piece construction. Upper security clamp member 52 is formed of a planar member 53 having an upper surface and a lower surface 54 and 56. Depending from the lower surface 56 is a perpendicular arm 58 having an aperture 59 at its lower end. Upper clamp member 52 is dimensioned such that depending arm 58 is inserted through aperture 28 in pintle ring 20, the surface area of planar member 53 is sufficient to deny access to completely cover aperture 28 of pintle ring 20. Upper clamp member 52 when positioned would rest or seat on the upper surface of pintle ring 20. In FIG. 4 the upper clamp member 52 is not yet fully seated.

Lower clamp member 60 of security clamp 50 comprises a planar member 62 having an upper surface 64 and a lower surface 66. Secured to the lower surface 66 is a cylindrical lock guard 68. As more fully illustrated in FIG. 6, cylindrical lock guard 68 is formed about a slot 70 formed through lower clamp member 60. In this configuration, when the upper clamp member 52 is fully seated on the upper surface of pintle ring 20, the depending arm member 58 extends through aperture 28 of pintle ring 20 and extends through the slot 70 formed in lower clamp member 60. The dimensions of the depending arm 58 and the depth of cylindrical lock guard 68 are such that when the upper clamp member 52 is seated on the upper surface of pintle ring 20, and lower clamp member 60 abuts the lower surface of pintle ring 20, the aperture 59 at the lower end of depending arm 58 is positioned within cylindrical lock guard 68 allowing the operator to place a padlock 74 through the aperture 59 thereby securing the upper and lower clamp members 52 and 60 together. The cylindrical lock guard 68 denies a potential thief access to the hasp 76 of the lock 74 such that the potential thief cannot utilize a bolt cutter to remove the lock and the security clamp 50.

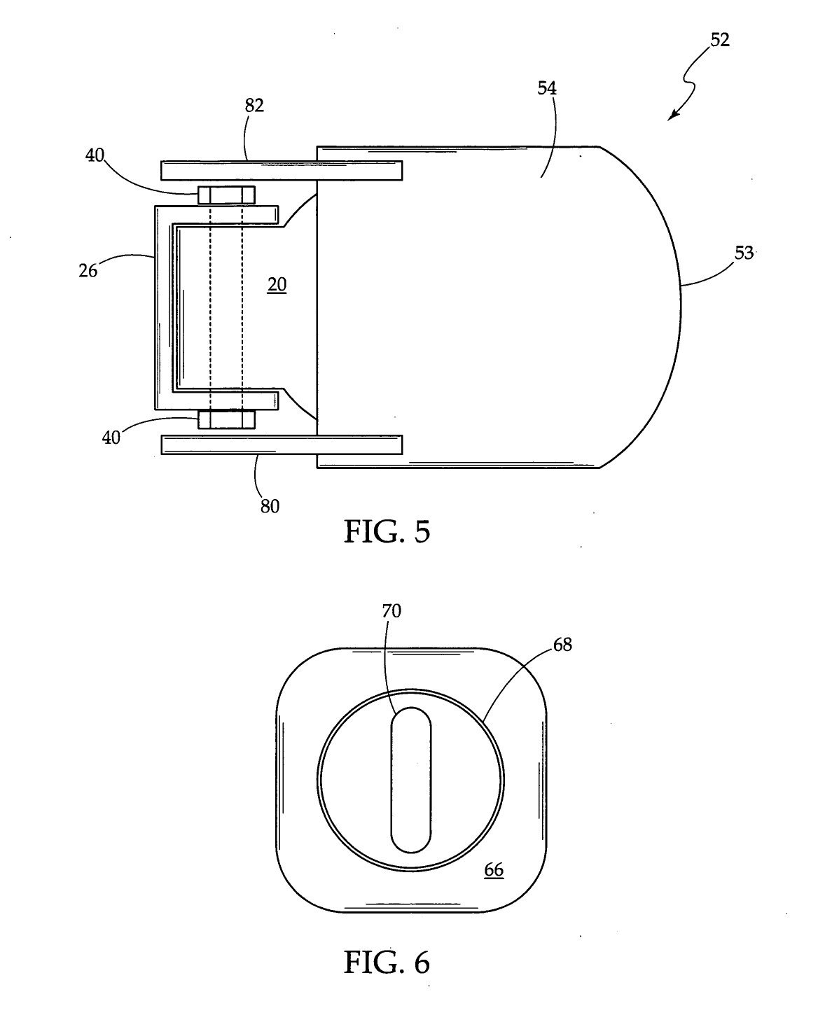

Applicant's security clamp has thus denied the potential thief access to use of the pintle ring 20 for connection to another pintle member 10. It is still necessary to deny the potential thief access to the securing means in the form of nuts and bolts 40 which secure the pintle ring 20 to bracket 26 and thus to the trailer. This is accomplished by two vertically disposed wings 80 and 82 as illustrated in FIG. 4 and in the top view of the security clamp 50 in FIG. 5. Wings 80 and 82 are secured to upper security clamp member 52 and extend rearwardly towards bracket member 26. As illustrated in FIG. 5, wings 80 and 82 are parallel with respect to each other and are illustrated in this manner for purposes of explanation only. It can be seen from the illustrations in FIGS. 4 and 5, that the wing members are dimensioned and positioned so as to extend over the vertical leg members 34 and 36 of bracket member 26 and thus deny spatial access to the securing means in the forms of nuts and bolts 40 which secure pintle ring 20 to the bracket member 26. In this manner, the potential thief does not have sufficient room within which to utilize a wrench or other tool so as to be able to remove the securing means and thus remove the entire pintle ring 20 from the bracket member 26.

It will be recognized by those of ordinary skill in the art that depending upon the size of the pintle ring and the bracket 20 and 26, and the dimension of the upper clamp member 52, that the wing members 80 and 82 may be parallel as illustrated in FIG. 5, or if the width of the upper clamp member 52 is greater than that illustrated, the wing members may be in angled or flared relationship extending rearwardly and over the leg members 34 and 36 of bracket 26 thus protecting the securing means.

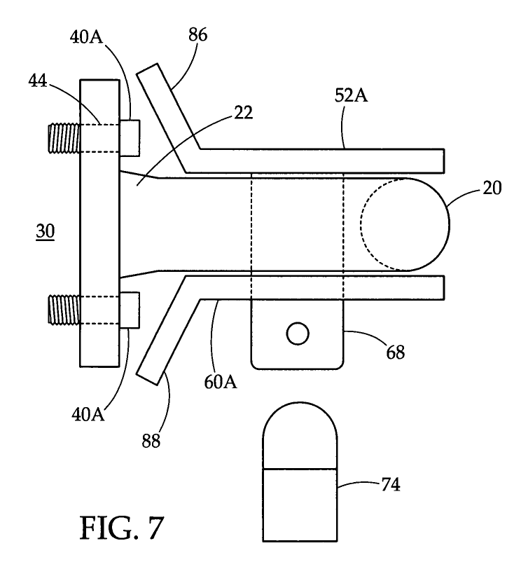

FIG. 7 illustrates a second embodiment of a security clamp for use with respect to a pintle ring mount as illustrated in FIG. 3. In this situation, there is no U-shaped bracket, but rather, just a bracket plate 44 which is secured to the pintle ring 20, the entire assembly being bolted onto a trailer. In this configuration, the securing means in the form of nuts and bolts 40A do not extend through the pintle ring 20 and pintle ring shoulder 22 laterally, but extend through the mounting plate 44 and onto the trailer. In this configuration, the upper clamp member 52A is identical as that in FIG. 4 with the acception that the wing members are not present, and the upper clamp member has an angular upward slant 86 proximate the shoulder 22 of pintle ring 20 which upper slant is at an angle and of a length sufficient to deny access to the upper bolt members 40A securing the bracket plate 44 to the trailer.

The lower bracket member 60A secures the lock 74 in the same manner as illustrated and described with respect to FIG. 4. The lower clamp member is extended in this particular configuration towards the shoulder 22 of pintle ring 20 and proximate shoulder 22, the lower clamp member has a downward slant 88 of sufficient length and angle so as to deny access to the lower bolts 23 utilized to secure vacuum plate 44 to a trailer. In this configuration the potential thief is denied access to the aperture 28 of pintle ring 20 in the same manner as described in FIG. 4, and also denied access to the mounting bolts 40A.

While this security clamp embodiment illustrates a protective angled slant for security of the bolts, the trailer ends of the upper and lower clamp members may incorporate a different geometric shape to accomplish the same purpose without departing from the spirit and scope of the invention.

It will be recognized by those skilled in the art and those familiar with trailer hitches, that a pintle ring hitch is a substantial item from the strength and weight standpoint because of the day to day wear and tear that it must encounter with the movement and positioning of construction trailers. Therefore the security clamp of the present invention must be of substantial construction in order that the potential thieves cannot readily attack the positioned clamp with hammers, crow bars, or the like, in order to disengage it. Therefore the preferred materials of construction with respect to the security clamps disclosed would be that of steel and the manner of securing the cylindrical lock protection and the wings, would be that of welding.

Therefore, while the present invention has been disclosed with respect to the preferred embodiments thereof, it will be recognized by those of ordinary skill in the art that various changes and modifications can be made without departing from the spirit and scope of the invention. It is therefore manifestly intended that the invention be limited only by the claims and the equivalence thereof.

I claim:

1. A security assembly for a pintle ring of a pintle hitch secured to a trailer and towing vehicle to prevent the unauthorized movement of an unhitched trailer, the pintle hitch comprising a pintle ring attached to said trailer, said pintle ring having a toroidal portion defining a horizontal aperture there through, a shoulder member integrally formed with said toroidal portion, said shoulder member secured to an attachment plate, which attachment plate is secured to said trailer by a plurality of threaded fasteners, the security assembly comprising:
an upper and lower security plate sandwiching said pintle ring and shoulder member there between, said upper security plate providing closure to said aperture in said toroidal portion and having a depending finger depending through said aperture in said toroidal portion, said depending finger having an aperture at its lower terminus, said lower horizontal security plate having an aperture for passage there through of said depending finger for receipt of a lock and hasp beneath said lower security plate, at least one of said upper or lower security plates having security wing panels extending there from which are juxtaposed said attachment plate, preventing access to said threaded fastener and preventing removal of said pintle ring.

2. The security assembly for a pintle ring of a pintle hitch in accordance with claim 1 wherein said shoulder member and said attachment plate are formed with alignable apertures for the receipt of threaded securing fasteners transverse to said shoulder member, said wing panels extending so as to juxtapose said horizontal threaded transverse fasteners denying spacial access thereto.

3. The security assembly for a pintle ring of a pintle hitch in accordance with claim 2 wherein said wing panels are vertically disposed from said upper or said lower security plate and are in parallel relationship.

4. The security assembly for a pintle ring of a pintle hitch in accordance with claim 2 wherein said wing panels are vertically disposed from said upper or said lower security plate, and are angularly flared outwardly so as to juxtaposed said horizontal transverse fastening means denying spacial access thereto.

5. The security assembly for a pintle ring of a pintle hitch in accordance with claim 1 wherein said toroidal portion, said shoulder member, and said attachment plate are of unitary construction and secured to said trailer by horizontal fasteners positioned above and below aid shoulder member extending through said attachment plate to a trailer frame, said upper security plate formed with an angular upturn juxtaposed said horizontal fasteners, and said lower security plate formed with an angular downturn juxtaposed said horizontal threaded fasteners denying spacial access thereto.

6. The security assembly for a pintle ring of a pintle hitch in accordance with claim 1 wherein said aperture in said lower horizontal securing plate for passage there through of said depending finger is formed with an annular wall thereabout for receipt of said padlock hasp in said aperture of said depending finger, said annular wall eliminating spacial mechanical access to said padlock hasp.

7. A security assembly for a trailer hitch of the pintle type to prevent the unauthorized movement of an unhitched trailer to which it is attached, said pintle hitch defined by a horizontal pintle ring having a horizontal aperture there through, an extending shoulder member integral with said pintle ring secured to an attachment plate, said attachment plate secured to a trailer by threaded fastening means, said security assembly comprising:
an upper horizontal oriented security plate having a first end and a second end positionable on an upper surface on said pintle ring, said first end substantially providing closure to said aperture of said pintle ring;
a depending finger on said first end of said upper horizontally oriented security plate, said depending finger depending through said horizontal aperture in said pintle ring, said depending finger having an aperture at its lower terminus;
a lower horizontally oriented security plate abutting a lower surface of said pintle ring, said lower horizontally oriented security plate having an aperture there through for the passage of said depending finger;
a padlock with padlock hasp, said hasp end engageable with said aperture in said depending finger;
a pair of security wing panels extending from said second end of said upper or lower security plates, said security wing panels juxtaposed said attachment plate for preventing access to said threaded fasteners and removal of said pintle ring.

8. The security assembly for a pintle ring of a pintle hitch in accordance with claim 7 wherein said shoulder member and said attachment plate are formed with alignable apertures for the receipt of threaded securing fasteners transverse to said shoulder member, said wing panels extending so as to juxtapose said horizontal threaded transverse fasteners denying spacial access thereto.

9. The security assembly for a pintle ring of a pintle hitch in accordance with claim 7 wherein said wing panels are vertically disposed from said upper or said lower security plate and are in parallel relationship.

10. The security assembly for a pintle ring of a pintle hitch in accordance with claim 7 wherein said wing panels are vertically disposed from said upper or said lower security plate, and are angularly flared outwardly so as to juxtaposed said horizontal transverse fastening means denying spacial access thereto.

11. The security assembly for a pintle ring of a pintle hitch in accordance with claim 7 wherein said toroidal portion, said shoulder member, and said attachment plate are of unitary construction and secured to said trailer by horizontal fasteners positioned above and below aid shoulder member extending through said attachment plate to a trailer frame, said upper security plate formed with an angular upturn juxtaposed said horizontal fasteners, and said lower security plate formed with an angular downturn juxtaposed said horizontal threaded fasteners denying spacial access thereto.

12. The security assembly for a pintle ring of a pintle hitch in accordance with claim 7 wherein said aperture in said lower horizontal securing plate for passage there through of said depending finger is formed with an annular wall thereabout for receipt of said padlock hasp in said aperture of said depending finger, said annular wall eliminating spacial mechanical access to said padlock hasp.
